(19) United States
(12) Patent Application Publication
(10) Pub. No.: US 2025/0089831 A1
(43) Pub. Date: Mar. 20, 2025

(54) Hat with Neck Protector for Entertaining a Child Riding on an Adults Back

(71) Applicant: Eric D. Ahrweiler, Natrona Heights, PA (US)

(72) Inventor: Eric D. Ahrweiler, Natrona Heights, PA (US)

(21) Appl. No.: 18/892,285

(22) Filed: Sep. 20, 2024

Related U.S. Application Data
(60) Provisional application No. 63/539,417, filed on Sep. 20, 2023.

(51) Int. Cl. A42B 1/0187; A42B 1/242; A42B 1/245; A61J 17/00

(52) U.S. Cl. CPC A42B 1/0187; A42B 1/242; A42B 1/245; A61J 17/1115

(57) ABSTRACT

A neck shield or cover adapted for extending from the lower rear rim (or band) of a hat to provide entertainment/educational activities, affixed to the shield, for a very young child riding on the hat wearer's back. The sunshade can be an aftermarket item or incorporated into new hat constructions. Optionally, a camera and display screen may be added. A method of use is also claimed.

### CROSS-REFERENCE TO RELATED APPLICATIONS

This application is a perfection of U.S. Provisional Application Ser. No. 63/539,417, filed on Sep. 20, 2023, the disclosure of which is fully incorporated by reference herein.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC OR AS A TEXT FILE VIA THE OFFICE ELECTRONIC FILING SYSTEM (EFS-WEB)

Not Applicable.

STATEMENT REGARDING PRIOR DISCLOSURES BY THE INVENTOR OR A JOINT INVENTOR.

Not Applicable.

### BACKGROUND OF THE INVENTION

Neck sunshades or covers that temporarily or permanently affix to the backside of a hat or other head gear are known. However, prior art neck sunshades or hoods have not been particularly adapted to drape properly on one's shoulders and retain their shape so that when worn, the shade components amply cover the wearers' necks. Deficiencies in past neck sunshades have been addressed in the art but a secondary consumer need remains.

Prior art neck sunshades have been known to drape or spread unevenly across the back of the wearer's neck. Or they do not consistently cover one's shoulders, especially when worn out of doors in both calm and windy conditions, or by persons who are undertaking a vigorous physical activity such as hiking or backpacking on trails or the like. Still further, due to the lack of proper configuration of such prior art sunshades or neck covers, they have not been suitable for displaying indicia thereon for the entertainment/education riding on an adult's back immediately adjacent such shades or covers. This invention focuses on that prior art deficiency.

### (1) FIELD OF THE INVENTION

The present invention relates to hats and caps, Particularly, it relates to a hat/cap with neckwear protection, typically from sunburn or the like. More particularly, it pertains to a flexible cover integral with, or otherwise attachable to, the back of a hat for protecting its wearer while carrying a young child on the wearer's back. The hat of this invention provides entertainment and educational “distractions” for the child being carried by an adult.

### (2) DESCRIPTION OF RELATED ART INCLUDING INFORMATION DISCLOSED UNDER 37 CFR 1.97 AND 1.98

Relevant Art—Prior disclosures pertinent to this invention include but are not limited to, in chronological order: U.S. Pat. Nos. 5,649,327, 5,860,165, 5,875,493, 6,233,745, Published U.S. Application No. 200401 39530, Published U.S. Application No. 20080066214 and WO2004066768.

### BRIEF SUMMARY OF THE INVENTION

The present invention provides an improved neck sunshade or cover adapted to be permanently or temporarily affixed, preferably, at or near the lower rear rim (or band) of a hat or cap so as to flow loosely over the wearer's ears and properly drape over his/her neck, shoulders and uppermost hack; while providing exchangeable entertainment activities for a toddler or young child riding on the hat wearer's back immediately adjacent said sunshade/cover either indoors or out. A method of use is also disclosed.

The invention also provides an improved neck shade/cover/shroud or shield which may be integrally formed as an incorporated component of such hats, caps and the like including ballcaps, boonie caps, bucket hats, skull caps, knit hats, welders caps, sunhats, etc. In yet another optional version, said caps and neck covers can include clips tether cords or other means for securing teethers pacifiers and/or any desired children's toys well within repeated reach of the toddler/young child. Preferred versions further include an otherwise optional camera and dropdown view screen.

While flexible, washable materials like canvas may be preferred, it is anticipated that sturdier, structurally rigid or semi-rigid cloths may be substituted therefor, Current marketing is proceeding under the Hike Nanny™ name Though other alternative branding options may include but are not limited to: Tippee Tots, Tots, Tykes, APEAK, ACES, and Papoose carriers.

### BRIEF DESCRIPTION OF THE SEVERAL VIEWS OF THE DRAWING(S)

Those skilled in the art will further appreciate still other objectives, improvements and advantages of the present invention upon reading the following detailed description made with reference to the accompanying drawings in which:

FIG. 1 is a side perspective view of a toddler-toting adult using one representative embodiment of this invention;

FIG. 2 is a rear perspective view of an adult wearing the neck protecting hat of one embodiment to which 3 representative toddler-entertaining activities have been temporarily affixed along with a pacifier tether cord;

FIG. 3 is a top plan view of a representative shroud neck shield showing a plurality of uppermost snap connectors, lowermost clamps at opposed ends, a pacifier strap connector cord and 3 representative D-shaped activity clamp connectors;

FIG. 4A is a left side view showing one embodiment of hat/cap to which an entertainment (and/or education) neck shield has been temporarily installed or clipped on;

FIG. 4B is a left side view of a first alternative version in which the neck shield component has been integrally formed with the hat proper;

FIG. 5 is a front plan view showing: a ballcap displaying a potential trademark logo for use with the present invention; and a neck shield interior;

FIG. 6A is a rear plan view showing one joinder variation in which lower edges of the neck shield are affixed at a lower end to one or more areas of the toddler carrier frame; and

FIG. 6B is a close view mockup of one strap dowel pin arrangement for accomplishing the supplemental connection means of FIG. 6A above.

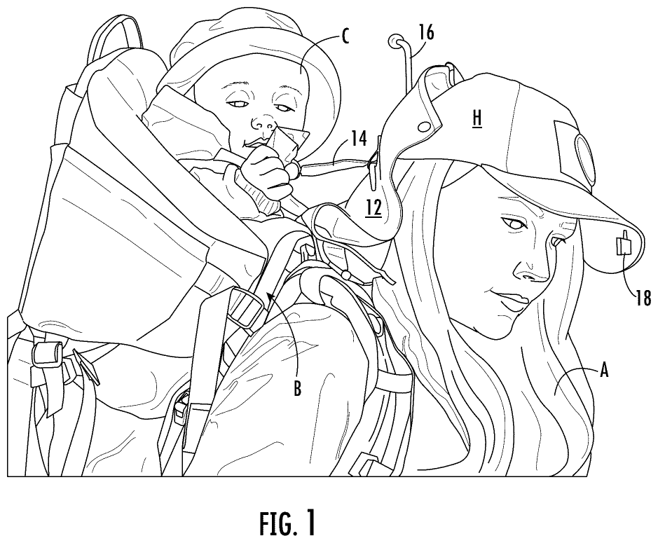

### DETAILED DESCRIPTION OF PREFERRED EMBODIMENTS

In the description that follows, it is important to note the primary goal of entertaining, educating or otherwise distracting/occupying the young child (not necessarily a newborn) or toddler being carried (or “worn”) on an adult's back, in a backpack or other suitable harness, while hiking, walking in the woods, transporting during fairs or festivals, or while on other athletic activities.

It is a primary goal to protect “the six”, or head and neck areas of the toddler carrier from hair pulling/twisting, puking and other undesirable toddler intrusions. These hat/cap concepts should further prevent said toddler from knocking off their carriers glasses or goggles from behind his/her ears.

A number of connecting means may be incorporated into versions of the present invention, including snaps, buckles, Velcro® straps, hooks, buttons, magnets and clamps.

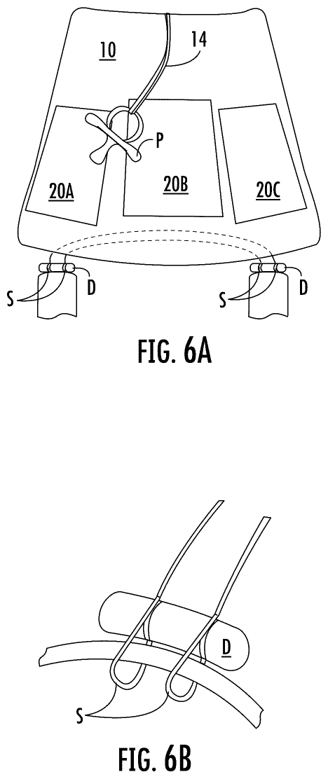

For a lower end of the neck shroud, it nay be desirable to FURTHER attach its lowermost edges at a secondary point to the backpack frame/cover before the toddler is situated therein. One representative lower edge clasping means includes the loop and dowel pin system represented in accompanying FIG. 6B. Still other anchor loop pairings may be substituted therefor.

It is anticipated that the initial purchase of a neck shroud/hat combination would include two or more toddler activities on the shield/shroud exterior. These can be tactile stimulating, like material driven touching panels, e.g., soft fuzzy/furry patches, leathery strips, textured strings, flexible mirrors, sound generating buttons (for animal noises or the like), slightly rougher surfaces, or any other materials commonly found on a younger child's playthings or activity center. Knobs, beads, Velcro® and/or zippered sections may be included as well. Depending on the developmental age of the toddler, these same substitutable panels may be used to start educational orientation exercises, like learning colors, animal shapes/sounds, numbers, letters, etc.

The activities can be predominantly visual, such as a soft-backed mirror, perhaps with safety lighted components, flashing fobs, etc. LED lights should be used when possible as they do not get too warm to the touch.

The interchangeable activity panels may also include sound stimulants that would not be overly irritating to the primary hat wearer—i.e., the toddler totter. Soft bells, scraping pads maybe even tethered whistles come to mind. These would be in addition to the pacifier connecting straps shown in some of the accompanying FIGS.

Weatherproofing aside, these panels may include one or more olfactory stimulant sections, and possibly even safety taste stimulants. These would be periodically reinforceable or “rechargeable” with new scents, for example.

Depending on material selections, the primary hat/cap component and the neck shroud can be intentionally color and/or feel coordinated.

In an alternative variation, a slightly more rigid version may be provided. This may include one or more vertically extending stays inside the shroud itself, or on an interior section thereof. Such stays/stiffeners would allow for easier draping of the shield over the neck when being used by the little one.

And as best comparatively seen in FIGS. 4A and B, such panels, or neck shields, can be intended for clipping, as an Add-On AO-10, to one's favorite hiking hat 1 (FIG. 4A); or by incorporating as an integral shield I-10 into a totally new, integral hat H construction (FIG. 4B). FIG. 5 shows a reverse angle of one embodiment of the invention with the hat H having its neck shield 10 draping down from the rear end RE.

Referring now to the accompanying FIGS., there is shown an adult A with her toddler child C situated in the backpack B situated on the adult's back. The adult A is shown wearing a ballcap/hat H onto the back of which is situated a first embodiment of neck shield, generally 10. On the outer face 12 of neck shield 10, there would be situated a plurality of toddler entertainment/educational activities, though none are even partially visible from this view. What is visible is the pacifier tether cord 14, and an add-on camera stem 16 wired to an add-on, drop down display screen 18 on the upper brim of hat H. For this particular embodiment of the invention, neck shield 10 is, itself, an add-on to an adult's pre-existing hat. Hence, the reasoning behind an overlap of the shield above the adult wearer's coat collar and lowermost hat back edge.

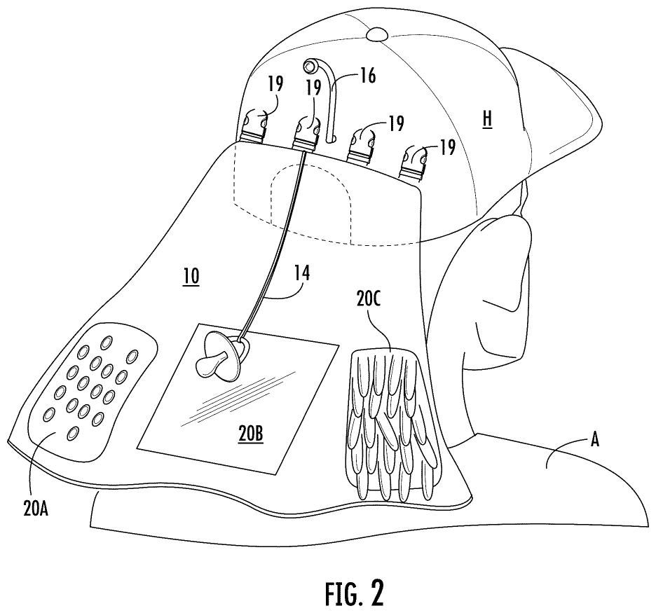

FIG. 2 is another retrofitted variety of neck shield 10 on the rearmost edge of hat H worn by adult A. As an add-on, neck shield 10 can be joined by a plurality of clip ends 19 (four are shown), from one of which is connected its own pacifier tether cord 14. Each clip end 19 consists of a plastic buckle. Alternate varieties of connecting shield 10 to the back of a hat H include a matching metal snap system, magnets, and/or hook and loop tape (or Velcro®) tabs.

On the rearmost flap of neck shield 10, there are situated a plurality of interchangeable, replaceable entertainment/educational activity panels 20A, 20B and 20C, the first being a lighted display variety 20A, the middle a square 20B for the toddler to rub along to make a soft sound and the far right being a patch 20C with a plurality of feely fingers extending downwardly from a base panel.

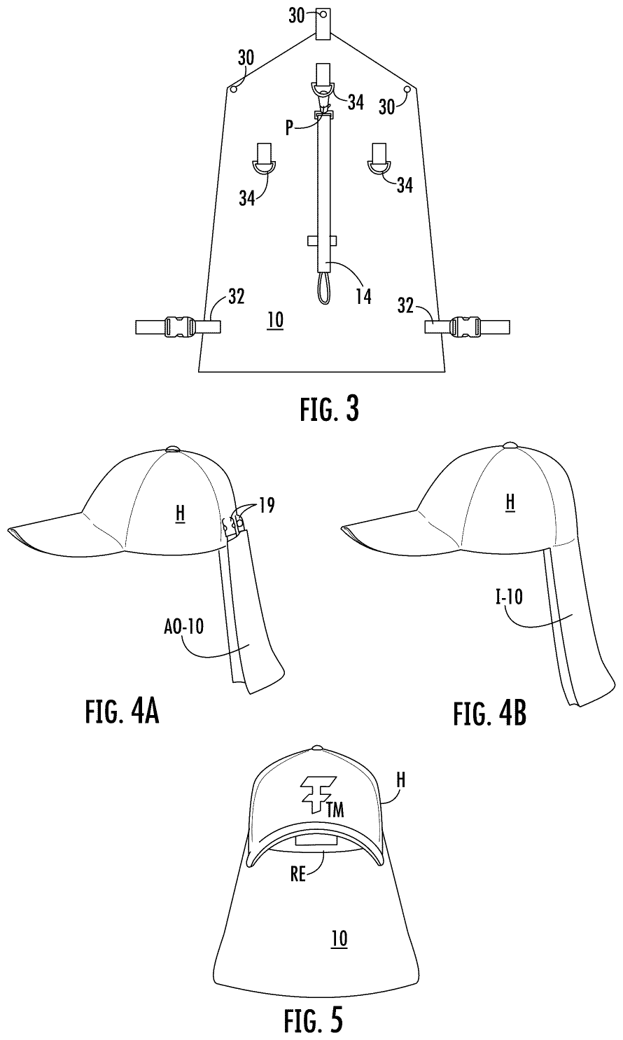

FIG. 3 is a representative configuration of attachable (after market) neck shield 10. It includes: a plurality of uppermost eyelets or snap connectors 30, lowermost clamps 32 at opposed ends, a pacifier strap connector cord 14 and three representative D-shaped clamp connectors 34 for affixing swap out activities to the outer back of said neck shield 10.

Lastly, FIGS. 6A and B illustrate one joinder variation in which the lower edges of neck shield 10 affix by wrapping about one or more sections of the toddler carrier frame or backpack (not shown) via strap tops S and slidable locking dowels D. FIG. 6B is a close-up view of said strap S and dowel D combination. It should be understood, however, that numerous other connection means may be employed for keeping the neck shields of this invention sufficiently attached to the back a wearer's hat, in place for a toddler to interact with the shield components 20A, B and B and still access the pacifier P, at the end of connector cord 14.

All of the foregoing match neck shields directly to the rear of a new or existing hat. It is to be understood that a less obtrusive shield hanging system could entail adding the shield to an appropriately sized and weighted headband, either temporarily or permanently. Then, that headband and shield combination could be fitted over a wearer's new or existing hat, cap or other appropriate head covering.

Although preferred embodiments of a neck cover or skirt have been described herein, those skilled in the art will recognize that various substitutions and modifications may be made to the invention without departing from the scope and spirit of the appended claims.

1. A neck shield for a hat to cover a hat wearer's neck and provide one or more occupying activities for a young child while being carried on a hat wearer's back adjacent the neck shield, said occupying activities attaching at least temporarily to the neck shield.

2. The neck shield of claim 1, which is adapted for temporarily attaching to a rear section of the hat and draping over the hat wearer's neck and the neck shield includes means for connecting the neck shield to the rear section of the hat.

3. The neck shield of claim 1 wherein the occupying activities include at least one age appropriate, accessory entertainment panel.

4. The neck shield of claim 3 wherein the accessory entertainment panel is exchangeable.

5. The neck shield of claim 3 wherein at least one of the occupying activities is educational.

6. The neck shield of claim 3 wherein the accessory entertainment panel includes at least one touch/tactile component.

7. The neck shield of claim 3 wherein the accessory entertainment panel includes at least one visual stimulant component.

8. The neck shield of claim 3 wherein the visual stimulant component includes a plurality of LED lights.

9. The neck shield of claim 3 wherein the accessory entertainment panel includes an auditory component.

10. The neck shield of claim 3 wherein the accessory entertainment panel includes an olfactory component.

11. The neck shield of claim 1, which is integrally formed as part of a new hat.

12. The neck shield of claim 1, which is made from a pliable canvas material.

13. The neck shield of claim 1, which includes one or more rigid or semi-rigid structural reinforcement components.

14. The neck shield of claim 1, which further includes one or more means for attaching to a top section of backpack/child carrier.

15. The neck shield of claim 1, which further includes a detachable camera and viewing screen combination.

16. A neck shield for a hat to cover a hat wearer's neck and provide one or more entertainment or educational activities for a young child while being carried on a hat wearer's back adjacent the neck shield, said entertainment or educational activities attaching interchangeably to the neck shield and including at least one of a visual stimulant, an auditory stimulant, a tactile stimulant and an olfactory stimulant.

17. The neck shield of claim 16, which is adapted for temporarily attaching to an existing hat.

18. The neck shield of claim 16, which is integrally formed with a new hat.

19. The neck shield of claim 16, which further includes a detachable camera and viewing screen combination.

20. A method for entertaining a young child while being carried on an adult's back, said method comprising the steps of:
(a) providing a hat having a draping rear neck shield with one or more entertainment activities for the young child while being carried on a hat wearer's back adjacent the neck shield, said entertainment activities attaching interchangeably to the neck shield and including at least one of a visual stimulant, an auditory stimulant, a tactile stimulant and an olfactory stimulant; and
(b) situating the young child in a child carrier so that the neck shield can be safely reached by the young child while being carried.
